(19) United States
(12) Patent Application Publication
(10) Pub. No.: US 2002/0083017 A1
(43) Pub. Date: Jun. 27, 2002

(54) Method and apparatus for providing improved management of a charging process over a network

(75) Inventor: Liisa Kanniainen, Parola (FI)

Correspondence Address: ALTERA LAW GROUP, LLC, 6500 CITY WEST PARKWAY, SUITE 100, MINNEAPOLIS, MN, 55344, US

(73) Assignee: Nokia Corporation

(21) Appl. No.: 09/749,174

(22) Filed: Dec. 27, 2000

(51) Int. Cl. G06F 17/60

(52) U.S. Cl. 705/80

(57) ABSTRACT

A method and apparatus that provides improved management of the charging process over a network is disclosed. The present invention uses a payment system to handle the contract negotiation process. The payment system includes a trusted server, the trusted server prepares a contract for a transaction between a merchant system and a buyer system, sends the prepared contract to the buyer system for acceptance by a user of the buyer system and returns the accepted contract to the merchant system wherein the merchant system initiates the transaction based upon the accepted contract and a charging engine for calculating a charge to be paid to the merchant system by the user based upon feedback from the merchant system.

### BACKGROUND OF THE INVENTION

1. Field of the Invention

This invention relates in general to electronic commerce over a computer network, and more particularly to a method and apparatus that provides improved management of the charging process over a network.

2. Description of Related Art

With the advent of electronic forms of communication, telegraph, telephone, radio, television, and digital networks, it has become possible to conduct commerce electronically. Ultimately, those who pay for something control it. Currently, most websites that don't sell things are funded by advertising. Thus, they will be controlled by advertisers and will become less and less useful to the users. A veritable arms race has already started with more and more annoying advertisements that intrude on the user's attention in at attempt to survive ever-declining click-through rates.

Annoying ads are ultimately self-defeating since people will avoid sites that do not give them a positive user experience. The Web is a user-driven phenomenon, where people go online for a purpose. Quite often, that purpose will be to buy something, so there is a great future for commercial sites that sell or support products and services. Traditional products can be charged to credit cards, but many Internet services will require incremental payments rather than large one-time payments.

Known electronic fund transfer systems generally require a “trusted” third party, between the vendor and consumer, to authenticate the validity of the electronic funds. The requirement of a third party adds expense to every transaction because of the cost of extra communications, and extra encryption. In addition, current electronic fund transfer networks, e.g. Western Union, and the Federal Reserve banks, typically require physically secure communications media which is immune to “eavesdropping.” Such secure networks are generally not available to consumers at large.

Alternative methods of electronic fund transactions involve establishing a relationship between the vendor and consumer, either through a subscription service, or billing accounts as are provided by credit card organizations. These methods are efficient at handling transaction requests, assuming a reasonable authentication scheme. However, these methods require a prior effort to establish an “account” or credit worthiness. For a large number of consumers, e.g. all potential users of a large network of computers known as internet, setting up accounts, and maintaining credit information adds expenses to the system.

The recent growth of public access communications networks, such as Internet, has accelerated the need for a low-cost computerized commerce system. In addition, in the information market place there is a particular need to economically support transactions that are for amounts as small as a hundredth of a cent. For example, single “pages” of copyrighted material in multi-media network repositories. Current computerized commerce systems, generally have transaction costs which far exceed the value of the products traded in “micro-commerce.”

Also current systems, using, for example, credit card organizations, have a low level of consumer privacy, since they maintain centralized records of purchases, and usually have a single point of trust.

If a service provided to a customer is considered a single or one-off event, it is natural to pay for it through a single transaction. The transaction may be performed using one of a variety of know mechanisms, such as electronic money or electronic purse, or the Secure Electronic Transaction (SET) protocol specified by credit card companies for making network payments.

On the other hand, if the service is continuous, it is to the advantage of the customer to pay for it in small increments, for example, once a minute for the next minute of service. With incremental payments the customer's losses remain small if delivery is interrupted; the loss is confined to the prepaid amount. Such an interruption may be intentional or unintentional. For example, in the middle of a transaction of a movie, the customer may decide to terminate the viewing, or there may be congestion in the network, which interrupts the delivery of the service.

Still, the management of the charging process needs to be improved. For example, a buyer often repudiates a transaction thereby forcing the seller to proved the validity of the transaction. However, the seller may find proving the validity of the transaction difficult because of insufficient payment confirmation. At the other end of the transaction, a buyer may be induced to provide personal financial information without sufficient proof of the authenticity of a seller and/or product.

It can be seen then that there is a need for a method and apparatus that provides improved management of the charging process over a network.

### SUMMARY OF THE INVENTION

To overcome the limitations in the prior art described above, and to overcome other limitations that will become apparent upon reading and understanding the present specification, the present invention discloses a method and apparatus that provides improved management of the charging process over a network.

The present invention solves the above-described problems by having a trusted server in a payment system handle the contract negotiation process. Preferable a payment system as such is able support existing merchant servers as well as enhanced merchant servers, which may take part in contract review and, if required, modify the initially proposed contract. In addition, the merchant server is preferably enabled to be updated to support new contract, that is configured after the merchant server is initially taken into use. The merchant system may indicate to payment system if the contract concerning the user selected product is enabled to be reviewed and necessary modified by the merchant system.

A payment system in accordance with the principles of the present invention includes a trusted server, the trusted server prepares a contract for a transaction between a merchant system and a buyer system, sends the prepared contract to the buyer system for acceptance by a user of the buyer system and returns the accepted contract to the merchant system wherein the merchant system initiates the transaction based upon the accepted contract and a charging engine for calculating a charge to be paid to the merchant system by the user.

Other embodiments of a payment system in accordance with the principles of the invention may include alternative or optional additional aspects. One such aspect of the present invention is that the merchant system identifies whether the trusted server can modify the contract.

Another aspect of the present invention is that the trusted server finalizes the content source.

Another aspect of the present invention is that the merchant system includes a web server.

Another aspect of the present invention is that the payment system further includes an interface between the merchant system and the buyer system, the interface including a Wireless Application Protocol (WAP) server for the buyer system supporting WAP connection.

Another aspect of the present invention is that the product further includes at least a portion of a content source.

Another aspect of the present invention is that the content source includes a document.

Another aspect of the present invention is that the content includes a multimedia object.

Another aspect of the present invention is that the buyer system includes a mobile terminal.

Another aspect of the present invention is that the mobile terminal includes a web-enabled mobile phone.

Another aspect of the present invention is that the buyer system includes a computer system coupled to the internet.

Another aspect of the present invention is that the payment system further includes a World Wide Web interface, the World Wide Web interface interfacing the buyer system and the mobile system.

Another aspect of the present invention is that the trusted server receives payment from the buyer system, confirms payment by the buyer system and prevents non-repudiation of the transaction by the buyer system.

Another aspect of the present invention is that the charging engine receives charging data representing billing information from the merchant system and transfers a charge amount to the buyer system for payment by the buyer system.

Another aspect of the present invention is that the charging engine converts the received charging data into another form ready to be transferred to the buyer system.

Another aspect of the present invention is that the trusted server receives payment from the buyer system based upon the charge amount sent to the buyer system, confirms payment by the buyer system and signals to the merchant system that payment has been made.

Another aspect of the present invention is that the trusted server provides authentication for the transaction to the buyer system.

Another aspect of the present invention is that the authentication for the transaction includes authentication of the product.

Another aspect of the present invention is that the authentication for the transaction includes authentication of the merchant system.

Another aspect of the present invention is that the payment system further includes a financial compensation system, the financial compensation system providing financial transaction support to the buyer system and the merchant system for the transaction.

In another embodiment of the present invention, an electronic commerce system is provided. The electronic commerce system includes at least one buyer system for operation by a user desiring to purchase a product, at least one merchant system configured for providing a user a product and at least one payment system, wherein the payment system handles the negotiation of a contract for a transaction between the merchant system and the buyer system concerning the product.

Another aspect of the present invention is that the payment system of the electronic commerce system includes a trusted server, the trusted server prepares the contract for the transaction between the merchant system and the buyer system, sends the prepared contract to the buyer system for acceptance by a user of the buyer system and returns the accepted contract to the merchant system wherein the merchant system initiates the transaction based upon the accepted contract and a charging engine for calculating a charge to be paid to the merchant system by the user.

In another embodiment of the present invention, a method for managing payments between a buyer system and a merchant system is provided. The method includes starting session from merchant system toward trusted system and asking trusted system for a contract for the transaction, sending by the trusted system the contract to the buyer system, signing the contract by the user and sending the contract back to the trusted system, validating the signature by the trusted system and sending the signed contract to the merchant system, sending charging data by the merchant system to the trusted system for processing charges of the buyer system and closing the transaction by the merchant system.

Another aspect of the present invention is that the method further includes calculating by a charging engine a charge to be paid to the merchant system by the user based upon feedback from the merchant system.

Another aspect of the present invention is that the calculating by the charging engine further includes receiving charging data representing billing information from the merchant system, if necessary, converting the charging data into a charge amount and providing the charge amount to the buyer system for payment by the buyer system.

Another aspect of the present invention is that the method further includes, after the trusted system is requested by the merchant system to prepare a contract for a transaction, returning the prepared contract from the trusted system to the merchant system; reviewing the contracting and, if necessary, modifying the contract by the merchant system before sending the contract back to the trusted system.

Another aspect of the present invention is that the method further includes processing the payment to financial compensation system by the trusted system after the merchant system has sent the charging data to the trusted system.

In another embodiment of the present invention, an article of manufacture including a program storage medium readable by a computer, the medium tangibly embodying one or more programs of instructions executable by the computer to perform a method for managing payments between a buyer system and a merchant system is provided. The method of the article of manufacture including starting session from merchant system toward trusted system and asking trusted system for a contract for the transaction, sending by the trusted system the contract to the buyer system, signing the contract by the user and sending the contract back to the trusted system, validating the signature by the trusted system and sending the signed contract to the merchant system, sending charging data by the merchant system to the trusted system for processing charges of the buyer system and closing the transaction by the merchant system.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a block diagram of a payment system according to the present invention; and

FIG. 2 illustrates a flow chart of the method for providing improved management of the charging process over a network according to a first embodiment of the present invention.

FIG. 3 illustrates a flow chart of the method for providing improved management of the charging process over a network according to a second embodiment of the present invention.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

The present invention provides a method and apparatus that provides improved management of the charging process over a network. The present invention uses a trusted server in a payment system to handle the contract negotiation process.

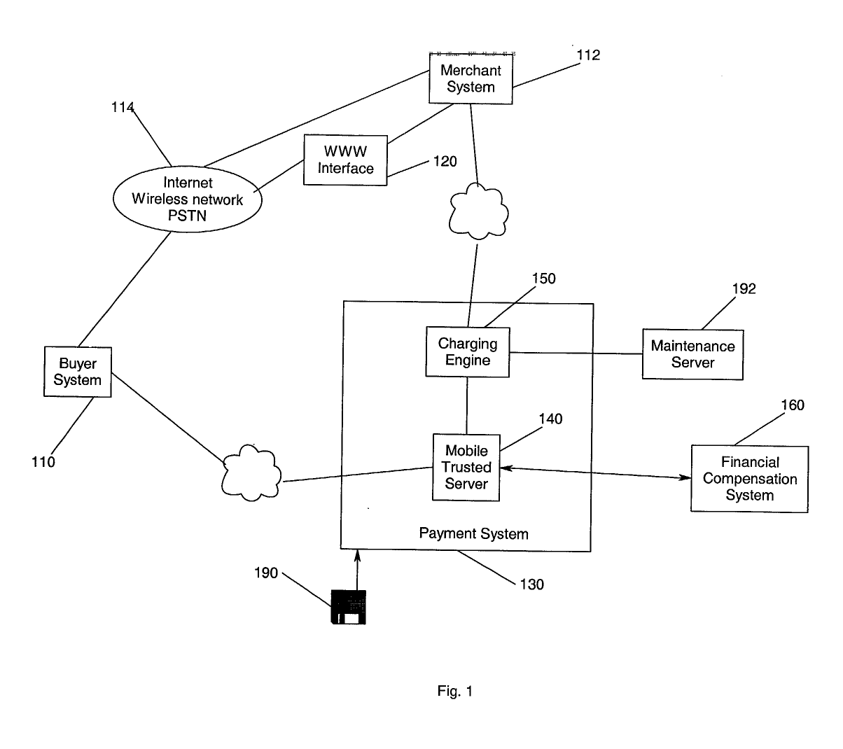

FIG. 1 illustrates a block diagram of a payment system 130 according to the present invention. In FIG. 1 a user desires to purchase, using a buyer system 110, a product from a merchant system 112. The buyer system 110 may be a computer, a personal digital assistant, a wireless mobile terminal (e.g., a web-enabled mobile phone), etc. The buyer system 110 may connect to the merchant system 112 through a cloud 114, such as the Internet, a wireless network, the public switched telephone network (PSTN), etc. Furthermore, an interface 120 may be needed to connect to the merchant system 112, e.g., a World Wide Web interface. For example, the buyer system 110 may be a Wireless Application Protocol (WAP) telephone and therefore may require connecting to a WAP server (acting as the WWW interface 120) to access a HTML server (acting as the merchant system 112). The merchant system 112 may be a web server. Further, those skilled in the art will recognize that the connections between elements of the payment system 130 and the buyer system 110 and between elements of the payment system 130 and the merchant system 112 may be through the Internet, a wireless network, the public switched telephone network (PSTN), etc.

The buyer system 110 starts a session toward from merchant system 112. The merchant system 112 asks a trusted server 140 of the payment system 130 for a contract for the transaction. The trusted server 140 returns a prepared contract to the merchant system 112. Additionally, in the second invention embodiment, the merchant system 112 may review the contract and, if necessary, modify the contract before sending the contract back to the trusted server 140. In the first and second invention embodiment, the trusted server 140 sends the contract to the buyer system 110. The user of the buyer system 110 signs the contract and sends the contract back to the trusted server 140. The trusted server 140 validates the signature and sends the signed contract to the merchant system 112. The merchant system 112 begins to send the product to the buyer system 110.

The merchant system 112 sends charging data to the trusted server 140 for processing charges of the buyer system 110. Service delivery may be single event or may last certain period of time. Thus, the charging data may include a single click representing a single event, or multiple pieces of charging information representing a portion of the product. It is advantageous for continuous service that the service is paid in small increments thus reducing losses for customer occurring due to congestion in the network, and buyer system 110 may decide to stop buying more while receiving a product from the merchant system 112. Thus, the product may include at least a portion of a content source (e.g., a document, music file, etc.) or a multimedia object (e.g., video, movie, etc.). Also, the merchant system 112 has an interest to prevent losses by being able to shut down the continuous service delivery. The charging data is processed by a charging engine 150 to determine charges to apply to the buyer system 110. The merchant system 112 can then close the transaction.

The trusted server 140 may also interface to a financial compensation system 160, such as bank systems, credit card payment systems, debit card payment systems, micro (PC) payment systems, etc. For example, organizations, which are not in the banking business, may act as payment operator and provide credit card type micropayment functionality by charging a credit card fee (e.g., $5). The charge is then put on the account of the operator and billed to the credit card through a Secure Electronic Transaction (SET) protocol wallet.

The trusted server 140 confirms payment and thus prevents non-repudiation by the user. The buyer system 110 receives a signed receipt of the payment when the trusted server 140 sends the end of payment to the buyer system 110. The signed receipt includes proof of payment including paid charging data. The trusted server 140 provides authentication of the sold product or merchant, and warranty (start date & validity) of the delivery of goods/services to the buyer system 110.

According to the second invention embodiment, the merchant system 112 can be updated to support a new contract for a product after receiving new control information or, if necessary, computer processable software of the contract may be downloaded via internet connection from a maintenance server 192 or alternatively from the payment system 130. In this way, the merchant system 112 is dynamically updated whenever new product or new contract of an existing product is required.

Those skilled in the art will recognize that the payment system 130 and the merchant system 112 may be located in the same system or server or alternatively separate hosts may be used, wherein the separate hosts may even belonging to different organizations. At least one system 150 in the network controls the changing and payment following up and controls the charging management as well as the support for mobility. The payment system 130 monitors online payment messages and in response to received information controls delivery of the service by sending control messages to the merchant system 112. Pricing of the service may change during service or the service may be priced using a more complex formula than a simple flat rate. This results in dynamic charging.

As described above, the delivery of the service starts after the buyer system 110 and the merchant system 112 agree on the price of the service and payment scheme. The contract is sent to the payment system 130, which controls the charging process.

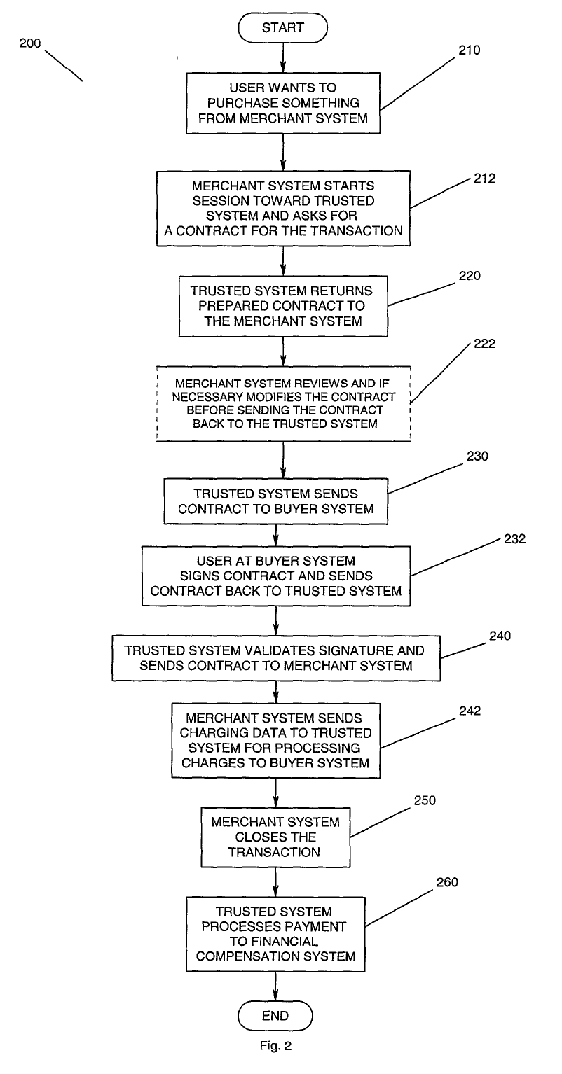

FIG. 2 illustrates a flow chart 200 of the method for providing improved management of the charging process over a network according to the present invention. In FIG. 2, a user wants to purchase something from a merchant system 210. The merchant system starts a session toward the trusted system and asks the trusted system for a contract for the transaction 212. The trusted system returns the prepared contract to the merchant system 220. Optionally, the merchant system may review the later received contract draft and, if necessary, modifies the prepared contract before sending the modified contract to the trusted system 222. The trusted system sends the contract to the buyer system 230. The user signs the contract and sends the contract back to the trusted system 232. The trusted system validates the signature and sends the signed contract to the merchant system 240. The merchant system sends charging data to the trusted system for processing charges of the buyer system 242. After the transaction is complete, or if payment is not received, the merchant system closes the transaction 250. The trusted system processes the charges of the product, i.e., the required payment is sent to the financial compensation system 260.

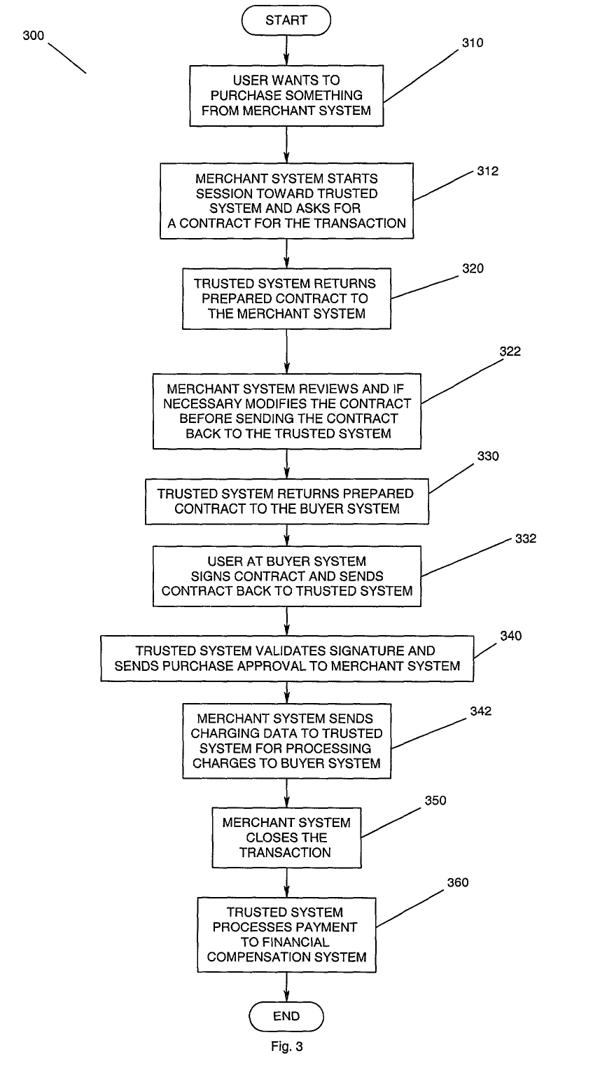

FIG. 3 illustrates second invention embodiment at a flow chart 300 of the alternative method for providing improved management of the charging process over a network according to the present invention. In FIG. 3, a user wants to purchase something from a merchant system 310. The merchant system starts a session toward the trusted system and asks the trusted system for a contract for the transaction 312. The trusted system returns the prepared contract to the merchant system 320. The trusted system sends the contract back to the merchant system 330. The user signs the contract and sends the contract back to the trusted system 332. The trusted system validates the signature and sends the signed contract to the merchant system 340. The charging data is sent by the merchant system to the trusted system for processing charges of the buyer system 342. After the transaction is complete or if payment is not received the transaction is closed by the merchant system 350. The payment order or request that is resulted of the charging data is sent to the financial compensation system 360 by the trusted system.

When the trusted system supports both embodiments of the present invention as described in FIGS. 2 and 3, the enhanced merchant system, when it starts a session toward the trusted system and asks the trusted system for a contract for the transaction 312, the merchant system reviews the later received contract draft and, if necessary, modifies the prepared contract 322.

The process illustrated with reference to FIGS. 1-3 may be tangibly embodied in a computer-readable medium or carrier 190, e.g. one or more of the fixed and/or removable data storage devices illustrated in FIG. 1, or other data storage or data communications devices. The computer program may be loaded into the payment system 130 to configure the payment system 130 for execution. The computer program includes instructions which, when read and executed by the payment system 130 of FIG. 1, causes the payment system 130 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A payment system, comprising:
a trusted server, the trusted server prepares a contract for a transaction between a merchant system and a buyer system, sends the prepared contract to the buyer system for acceptance by a user of the buyer system and returns the accepted contract to the merchant system wherein the merchant system initiates the transaction based upon the accepted contract; and
a charging engine for calculating a charge to be paid to the merchant system by the user.

2. The payment system of claim 1 wherein the merchant system identifies whether the trusted server can modify the contract.

3. The payment system of claim 2 wherein the trusted server finalizes the content source.

4. The payment system of claim 1 wherein the merchant system comprises a web server.

5. The payment system of claim 1 further comprising an interface between the merchant system and the buyer system, the interface including a Wireless Application Protocol (WAP) server for the buyer system supporting WAP connection.

6. The payment system of claim 1 wherein the product further comprises at least a portion of a content source.

7. The payment system of claim 5 wherein the content source comprises a document.

8. The payment system of claim 5 wherein the content comprises a multimedia object.

9. The payment system of claim 1 wherein the buyer system comprises a mobile terminal.

10. The payment system of claim 9 wherein the mobile terminal comprises a web-enabled mobile phone.

11. The payment system of claim 1 wherein the buyer system comprises a computer system coupled to the internet.

12. The payment system of claim 1 further comprising a World Wide Web interface, the World Wide Web interface interfacing the buyer system and the mobile system.

13. The payment system of claim 1 wherein the trusted server receives payment from the buyer system, confirms payment by the buyer system and prevents non-repudiation of the transaction by the buyer system.

14. The payment system of claim 1 wherein the charging engine receives charging data representing billing information from the merchant system and transfers a charge amount to the buyer system for payment by the buyer system.

15. The payment system of claim 14 wherein the charging engine converts the received charging data into another form ready to be transferred to the buyer system.

16. The payment system of claim 14 wherein the trusted server receives payment from the buyer system based upon the charge amount sent to the buyer system, confirms payment by the buyer system and signals to the merchant system that payment has been made.

17. The payment system of claim 1 wherein the trusted server provides authentication for the transaction to the buyer system.

18. The payment system of claim 17 wherein the authentication for the transaction comprises authentication of the product.

19. The payment system of claim 17 wherein the authentication for the transaction comprises authentication of the merchant system.

20. The payment system of claim 1 further comprising a financial compensation system, the financial compensation system providing financial transaction support to the buyer system and the merchant system for the transaction.

21. An electronic commerce system, comprising:
at least one buyer system for operation by a user desiring to purchase a product;
at least one merchant system configured for providing a user a product; and
at least one payment system, wherein the payment system handles the negotiation of a contract for a transaction between the merchant system and the buyer system concerning the product.

22. The electronic commerce system of claim 21 wherein the payment system comprises:
a trusted server, the trusted server prepares the contract for the transaction between the merchant system and the buyer system, sends the prepared contract to the buyer system for acceptance by a user of the buyer system and returns the accepted contract to the merchant system wherein the merchant system initiates the transaction based upon the accepted contract; and
a charging engine for calculating a charge to be paid to the merchant system by the user.

23. The electronic commerce system of claim 22 further comprising a World Wide Web interface, the World Wide Web interface interfacing the buyer system and the merchant system.

24. The electronic commence system of claim 23 wherein the interface between the merchant system and the buyer system includes a Wireless Application Protocol (WAP) server supporting WAP connection.

25. The electronic commerce system of claim 22 wherein the trusted server receives payment from the buyer system, confirms payment by the buyer system and prevents non-repudiation of the transaction by the buyer system.

26. The electronic commerce system of claim 22 wherein the charging engine receives charging data representing billing information from the merchant system and transfers a charge amount to the trusted server, the trusted server then providing the charge amount to the buyer system for payment by the buyer system.

27. The electronic commerce system of claim 26 wherein the charging engine converts the received charging data into another form ready to be transferred to the buyer system.

28. The electronic commerce system of claim 26 wherein the trusted server receives payment from the buyer system based upon the charge amount sent to the buyer system, confirms payment by the buyer system and signals to the merchant system that payment has been made.

29. The electronic commerce system of claim 22 wherein the trusted server provides authentication for the transaction to the buyer system.

30. The electronic commerce system of claim 29 wherein the authentication for the transaction comprises authentication of the product.

31. The electronic commerce system of claim 29 wherein the authentication for the transaction comprises authentication of the merchant system.

32. The electronic commerce system of claim 21 further comprising a financial compensation system, the financial compensation system providing financial transaction support to the buyer system and the merchant system for the transaction.

33. The electronic commerce system of claim 21 wherein the merchant system comprises a web server.

34. The electronic commerce system of claim 21 wherein the product further comprises at least a portion of a content source.

35. The electronic commerce system of claim 34 wherein the content source comprises a document.

36. The electronic commerce system of claim 34 wherein the content source comprises a multimedia object.

37. The electronic commence system of claim 21, wherein the merchant system indicates to the payment system the merchant system's capability to modify the contract.

38. The electronic commerce system of claim 21 wherein the buyer system comprises a mobile terminal.

39. The electronic commerce system of claim 38 wherein the mobile terminal comprises a web-enabled mobile phone.

40. The electronic commerce system of claim 21 wherein the buyer system comprises a computer system coupled to the Internet.

41. A method for managing payments between a buyer system and a merchant system, comprising:
starting session from merchant system toward trusted system and asking trusted system for a contract for the transaction;
sending by the trusted system the contract to the buyer system;
signing the contract by the user and sending the contract back to the trusted system;
validating the signature by the trusted system and sending the signed contract to the merchant system;
sending charging data by the merchant system to the trusted system for processing charges of the buyer system; and
closing the transaction by the merchant system.

42. The method of claim 41 further comprising calculating by a charging engine a charge to be paid to the merchant system by the user based upon feedback from the merchant system.

43. The method of claim 42 wherein the calculating by the charging engine further comprises receiving charging data representing billing information from the merchant system, if necessary, converting the charging data into a charge amount and providing the charge amount to the buyer system for payment by the buyer system.

44. The method of claim 41 further comprising, after the trusted system is requested by the merchant system to prepare a contract for a transaction, returning the prepared contract from the trusted system to the merchant system; reviewing the contracting and, if necessary, modifying the contract by the merchant system before sending the contract back to the trusted system.

45. The method of claim 42 further comprising processing the payment to financial compensation system by the trusted system after the merchant system has sent the charging data to the trusted system.

46. An article of manufacture comprising a program storage medium readable by a computer, the medium tangibly embodying one or more programs of instructions executable by the computer to perform a method for managing payments between a buyer system and a merchant system, the method comprising:
starting session from merchant system toward trusted system and asking trusted system for a contract for the transaction;
sending by the trusted system the contract to the buyer system;
signing the contract by the user and sending the contract back to the trusted system;
validating the signature by the trusted system and sending the signed contract to the merchant system;
sending charging data by the merchant system to the trusted system for processing charges of the buyer system; and
closing the transaction by the merchant system.

47. The article of manufacture of claim 46 further comprising calculating by a charging engine a charge to be paid to the merchant system by the user based upon feedback from the merchant system.

48. The article of manufacture of claim 47 wherein the calculating by the charging engine further comprises receiving charging data representing billing information from the merchant system, converting the charging data into a charge amount and providing the charge amount to the buyer system for payment by the buyer system.

49. The article of manufacture of claim 46 further comprising, after the trusted system is requested by the merchant system to prepare a contract for a transaction, returning the prepared contract from the trusted system to the merchant system; reviewing the contracting and, if necessary, modifying the contract by the merchant system before sending the contract back to the trusted system.

50. The article of manufacture of claim 42 further comprising processing the payment to financial compensation system by the trusted system after the merchant system has sent the charging data to the trusted system.
